(19) United States
(12) Patent Application Publication
(10) Pub. No.: US 2014/0120900 A1
(43) Pub. Date: May 1, 2014

(54) Safeguarding User Data Stored in Mobile Communications Devices

(71) Applicant: Keith COCITA, Santa Cruz, CA (US)

(72) Inventor: Keith COCITA, Santa Cruz, CA (US)

(21) Appl. No.: 13/663,225

(22) Filed: Oct. 29, 2012

(51) Int. Cl. H04W 12/02; H04W 88/02

(52) U.S. Cl. 455/419; 455/558

(57) ABSTRACT

A mobile communications device is configured to store a disable code set and defined by a user of the communications device. In the event that the mobile communications device is lost or stolen, the use contacts the lost or stolen mobile communications device from another communications device, transmitting to the lost or stolen mobile communications device an on-air disable code. Match circuitry in the lost of stolen communications device compares the received disable code to the disable code previously set and stored in the lost or stolen mobile communications device. If the match circuitry determines that the received disable code matches the stored disable code, access to private user data in the lost or stolen mobile communications device is prevented.

### CROSS-REFERENCE TO RELATED APPLICATIONS

The present application is a division of U.S. patent application Ser. No. 12/637,560, filed on Dec. 14, 2009, which is a continuation of U.S. patent application Ser. No. 11/112,020, filed on Apr. 21, 2005, which is a division of U.S. patent application Ser. No. 10/405,348, filed on Apr. 1, 2003, which claims the benefit of U.S. Provisional Patent Application No. 60/369,431, filed on Apr. 2, 2002, the disclosures of which are hereby incorporated by reference in their entireties for all purposes.

### FIELD OF THE INVENTION

The present invention is directed to cell phones with memory, and to a method and apparatus for safeguarding the private, owner information entered into the cell phone memory, and to the use of a telecommunications network to remotely erase cell phone memory.

### BACKGROUND OF THE INVENTION

Modern telecommunications networks include mobile stations, such as cell phones, which utilize a SMARTCARD which includes a SIM (subscriber identity module). The SIM's have a memory chip that contains data such as the identity of the card holder (i.e., the service subscriber), billing information, and home location. When a cell phone user places a call, the SIM communicates the unique SIM code to the network. The network checks to see if the SIM code owner is a current subscriber to the network service, often by matching the SIM code with a list of authorized SIM codes. This authentication, or matching of SIM codes generally precedes all other network communication with the cell phone.

SMARTCARDs were developed to allow cell phone activities other than simple telephone calls. The SMARTCARD can contain microprocessors for, e.g., transaction management, data encryption and user authentication. The SMARTCARD or the SIM may include subscriber entered telephone numbers and other valuable information. Theft of the phone places this valuable information in the hands of others. In fact, the loss of the phone is probably less important than the loss of the valuable information contained therein. This is especially true for the new cell phones which now access the Internet, and for cell phones coupled with handheld computing devices, which browse the Internet, store Power Point presentations, and do rudimentary word processing, as well as scheduling appointments and maintaining expense accounts.

Many security features have been developed for cell phones. Most of these are related to prevention of theft of communication services by permanently disabling a stolen phone, temporarily disabling a phone for which the subscriber is in arrears, or blocking calls to geographical regions which are not part of the subscriber's contract.

U.S. Pat. No. 5,898,783 discloses a telecommunications network with disabling circuitry which can disable the SMARTCARD of the cell phone of a particular subscriber. The disable command can permanently incapacitate the SMARTCARD by destroying the power connection for the logic circuitry, or temporarily incapacitate the logic circuitry by erasing the memory within the card. According to this patent, the numbers of stolen phones can be reported to the network and entered into a database which is searched when any cell phone requests service, and a disable command or signal returned to the cell phone if its number is in the disable database. In the present invention, the subscriber erases the memory containing the private information without the additional steps and involvement of the network, giving the subscriber greater freedom and opportunity to safeguard their private information.

U.S. Pat. No. 5,734,978 describes a telecommunications system having a manufacturer preset destruct code stored in each cell phone. When a subscriber reports a phone stolen, the network's base station controller initiates a destruct program, using the destruct code. The destruct code destroys the data necessary for performing the telephone functions, but not the private data.

U.S. Pat. No. 6,259,908 describes a cellular phone system in which a locking code on a particular cell phone may be erased by means of a message transmitted through the cell phone system, but may not be erased or changed using the keyboard features of that phone. This arrangement has particular usefulness in a designated cellular system with many units, such as a communications network for the fire department of a large city. To set up or reconfigure the network, the entire network must be activated and the individual units (cell phones) assigned a particular number. According to the patent, all phones on the system have a locking code to prevent theft communications on the network until all units are assigned. This is a subscriber system approach to preventing theft of service of the communications system, and does not relate to the privacy of data of individual subscribers.

### SUMMARY OF THE INVENTION

It is an object of the present invention to safeguard the private data entered into a cell phone by its owner, by permitting the owner to erase or destroy that data using an on-air signal. According to the present invention, the memory chip of a cellular phone on which private data is recorded may be provided with an erase means. This erase means could comprise a fuse, switch, or similar device in a disable, or erase, circuit. The erase means executes an erase command on receiving an on-air erase code which matches the erase code preset by the owner. If the mobile phone is lost or stolen, the owner need only call the telephone number of the lost or stolen phone and enter the erase code. The private data will be erased. Thus, the owner can protect the phone numbers and the addresses of family, friends and associates. If the owner believes the phone has been misplaced, he can destroy the private information without disabling the telephone features, should the missing phone be found.

It is also an object of the present invention to maintain the privacy and integrity of the cell phone owner's data, as well as to facilitate its transfer to a new cell phone. The integrity of the private data can be maintained with a novel recharging cradle or station. According to the present invention, the cell phone recharging cradle or station may incorporate a slot for a memory device, such as a PCMCIA card, which communicates with a phone docked in the cradle. Every time the phone is placed in the cradle for recharging the PCMCIA card does a check sum of the phone's memory. If numbers or other data have been entered into the phone, the card downloads that information so that the card is always updated. When a new phone is charged in the base station, the check sum is started, and all private data entered into the previous phone is automatically uploaded into your new phone. Using this system, if the user does not want anyone else to have access to their numbers they may simply remove the PCMCIA card from the phone. Also, a backup card can be easily carried in a wallet, when traveling.

These objects, as well as other objects which will become apparent from the discussion that follows, are achieved, in accordance with the present invention, which comprises a cell phone programmable memory chip with erase means; a recharging cradle with slot for, e.g., a PCMCIA card, which can upload data from, or download data into, a cell phone docked therein; and a cell phone apparatus with a) first memory for storing the unique identification numbers of the apparatus, b) transmitting/reception means for transmitting and receiving a call in accordance with said identification numbers, c) an EEPROM with a programmable data base for data, and a predetermined address (or memory location) for an erase code, d) means for entering erase code at the predetermined location, and e) erasing means for erasing said database on receipt of the erase code.

These objects are also achieved by the method of the present invention, for safeguarding private data stored in a selected cell phone on a mobile telecommunications system which comprises a plurality of individual mobile cell phone apparatus and a mobile telephone switching office, said at least one selected apparatus having a PROM for storing private data including an erase code, and a unique telephone number, said method comprising receiving at the selected mobile phone apparatus, from the switching network, a message containing the erase code from the switching network, and erasing the private data.

For a full understanding of the present invention, reference should now be made to the following detailed description of the preferred embodiments of the invention as illustrated in the accompanying drawings.

### BRIEF DESCRIPTION OF THE DRAWINGS

FIG. 1 illustrates a cell phone, or mobile telecommunications apparatus, and the SMARTCARD that is received therein, which cooperates with the cell phone to effect communication with a telecommunications network.

FIG. 2 illustrates a block diagram of a SMARTCARD according to the principles of the present invention.

FIG. 3 illustrates a block diagram of a telecommunications network capable of communicating with a plurality of cell phones that cooperate with a SMARTCARD to effect communication with the telecommunications network.

FIG. 4 illustrates a block diagram of a cell phone re-charging cradle according to one embodiment of the invention.

### DESCRIPTION OF THE PREFERRED EMBODIMENTS

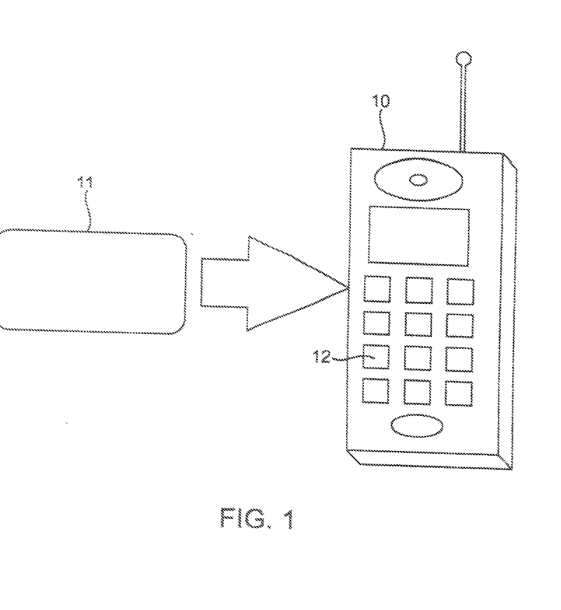

The preferred embodiments of the present invention will now be described with reference to FIGS. 1-4 of the drawings. Identical elements in the various figures are designated with the same reference numerals.

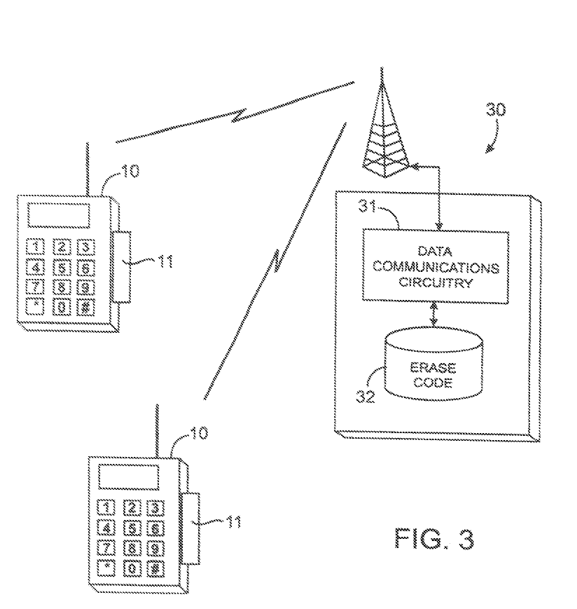

As shown in FIG. 1, the cell phone 10 receives the SMARTCARD 11 which cooperates with the cell phone to effect communication with a telecommunications network, such as that illustrated in FIG. 3. The SMARTCARD, includes a SIM (subscriber identity module). The SMARTCARD identifies the user of the telecommunications system, and serves to authenticate the user as one permitted on the network. The SMARTCARD may also encrypt communications between the cell phone 10 and the telecommunications network. The alphanumeric keys, 12 of the cell phone may be used to enter information into the cell phone memory, and are the preferred means for entering the erase code.

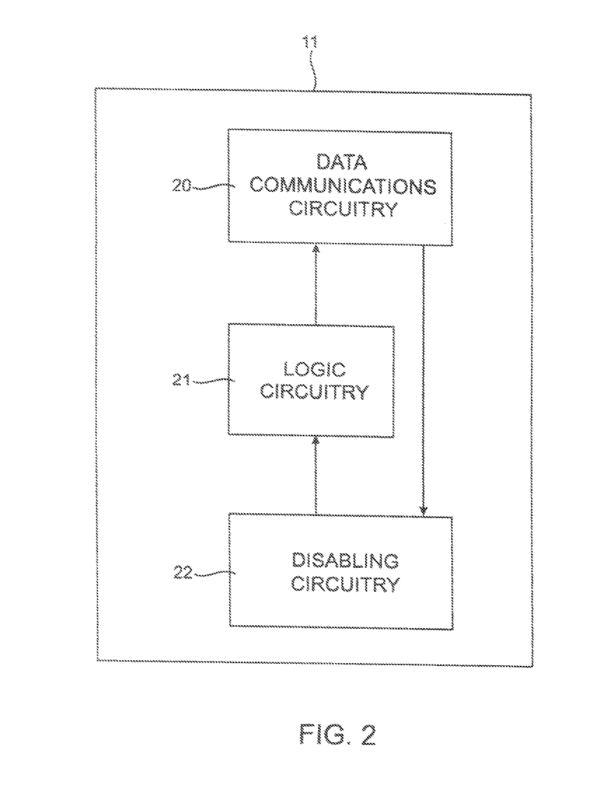

The elements of the SMARTCARD, illustrated in FIG. 2, include a data communications circuitry, a logic circuitry and a disabling, or erasing, circuitry. The data communications circuitry, 20, transmits a code uniquely identifying the SMARTCARD. The logic circuitry, 21, in the present embodiment includes data processing and storage circuitry and interconnecting circuitry, including, without limitation, a processor, memory, support circuitry, and any address, data and control buses (not shown). In one embodiment of the present invention the logic circuitry encrypts communication between the cell phone and the telecommunications network. As cell phones develop, the logic circuitry may be used to perform more and more functions, without affecting the features of the logic circuitry essential to the present invention.

The card is provided with disabling circuitry, 22, which can e.g., permanently erase the memory of the card. The disabling circuitry may comprise either a fuse or a switch, which operates to e.g. decouple the electrical power from the memory in card. Other means of effectively erasing the memory are known to those in the art, as by providing an excessive voltage that causes the memory to malfunction, even if it is still receiving power, or permanently incapacitating the logic circuitry by cutting it off from its source of power.

A block diagram of the telecommunications network is illustrated in FIG. 3. The telecommunications network, 30 is capable of communication with a plurality of cell phones 10 with cards, 11, having a subscriber identity module. Each card has a unique SIM code. Upon initiation of access to the network, the SIM code is transmitted to the network. The network, 30 has data communications circuitry, 31, to receive the SIM code. In one embodiment of the invention, the network may also include a PROM or an EEPROM for receiving and storing an erase code associated with a unique SIM code. In another embodiment of the invention, the data communications circuitry, 31, may also include an erase command.

The operation of the method and apparatus of the present invention will now be described. The user of SMARTCARD may use the alphanumeric keys, 12 to enter into, and store in the memory, an erase code to permit erasure of private data in the phone. According to a preferred embodiment of the present invention, the erase code for any selected cell phone may only be directly entered into the phone, using the keypad for that phone. The erase code may be stored in memory on the SMARTCARD, or may be transferred to, and stored on, the network. The erase code for a particular SMARTCARD or SIM may not be preset or changed by an on-air signal from a cell phone with a different SIM. The erase command maybe included in the data communications circuitry of the card or on the network.

If the cell phone is stolen or lost, the user may, using another cell phone or a land line, call the telephone number of the stolen or lost cell phone, and enter the erase code. The data communications circuitry of the network and the lost phone “matches” the erase code of the on-air communication with the preset stored erase code. The “matching” may involve an exact matching of characters, or an exact mapping, requiring a specific relationship, between the preset erase code and the received erase code. If there is a match, an erase command is issued, and the private data in the stolen or lost cell phone is erased. The circuitry for executing the erase command is in the cell phone.

The present invention does not require a network database of erase codes, permitting great individual privacy. In addition, the user does not need to access disable commands on the network. No database of disabled numbers needs to be assembled and maintained by and at the network in order for the user to disable the memory for his private data. When the erase code is stored in the cell phone, it is instantly operable. In addition it may be instantly changed. The privacy of data entered into cell phones is of increasing importance. New phones incorporate Internet text messaging, e-mail, and web surfing and downloading. Elaborate negotiations may now be conducted via a cell phone. In addition, cell phones are being combined with handheld computers and organizers, which contain word processing. Entire contracts may be recorded, transmitted, or received on a handheld apparatus including a cell phone on a telecommunications network.

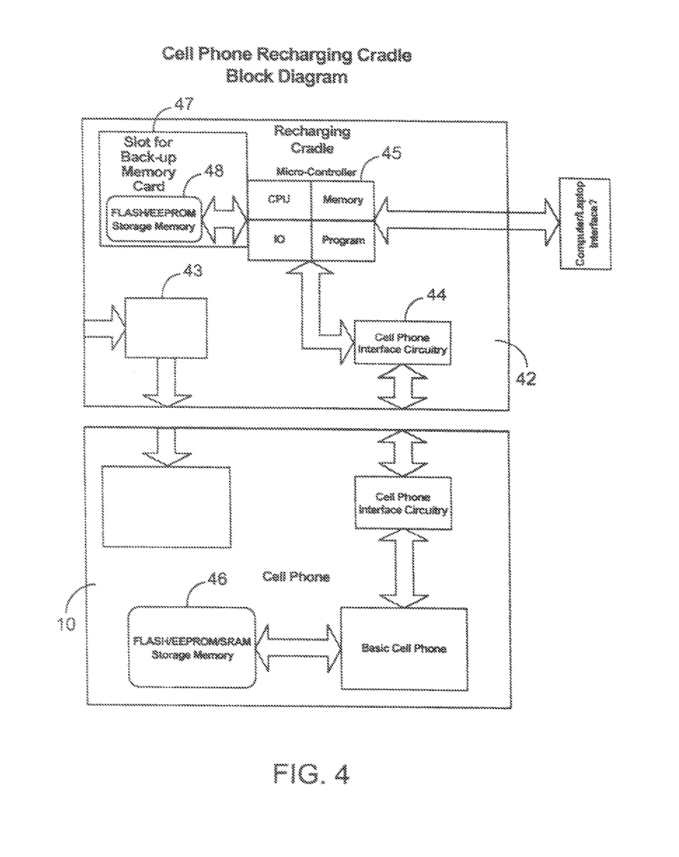

FIG. 4 illustrates a preferred embodiment of a recharging cradle, 42, according to the present invention. The cradle includes recharging circuitry, 43, which connects to the phone, 10, when the phone is in the dock, as shown in FIG. 4. Also included in the cradle is cell phone interface circuitry, 44, which comprises an upload/download cell phone memory device, comprising a micro-controller, 45, which comprises a CPU, a memory, IO (input output) and the program or application. The program compares the memory in the phone memory, as shown here as the erasable FLASH/EEPROM/SRAM storage memory, 46, which is part of the present invention, with the memory in the cradle, as with a check sum operation; and downloading to the cradle memory any numbers which have been added to the phone, and uploading to the phone any numbers in the cradle memory which are not in the phone.

As shown in FIG. 4, the recharging cradle may further comprise an upload/download slot, 47, for a back-up cell phone memory device, 48. The slot comprises a micro-controller, and interface circuitry in communication with either the memory in a docked cell phone, or, as shown, with the memory in the cradle. The back-up memory device may be any device suitable for insertion into a new phone, such as a PCMCIA card. As shown in FIG. 4, this PCMCIA card is provided with an erasable memory.

These back-up devices provide a very convenient means for maintaining the integrity of private data for the cell phone. If the cell phone is stolen or lost, no time need be taken in an attempt to recover the stored private data, but the private data immediately erased, as a duplicate copy exists in the cradle, and optionally on the back-up PCMCIA. The back-up PCMCIA is easily stored in a wallet, while traveling, and may be placed into a new cell phone, or the PCMCIA card kept in the cradle, and data therein transferred to a new cell phone docked in the cradle. If the new cell phone has to be initially charged, charging in the cradle with PCMCIA card slot will enter all the private data into the new cell phone.

In another aspect of the present invention, a novel recharging cradle for the cell phone may be provided with an upload/download slot for receiving an additional memory device or card, such as a PCMCIA card, for maintaining the integrity of private data for the cell phone. The slot comprises a micro-controller, crystal and interface circuitry, connecting the memory device in the slot and the memory device in the phone. Once placed in the slot, the e.g. PCMCIA card is in communication with any cell phone docked in the cradle. On docking the cell phone in the cradle a check sum may be initiated, and any new data from the cell phone added to the PCMCIA card. Then, should the cell phone be stolen or lost, no time for recovery of the stored private data need be allotted, but the private data immediately erased, as a duplicate copy exists on the spare PCMCIA. The spare PCMCIA is easily stored in a wallet, while traveling, and may be placed into a new cell phone, or the PCMCIA card kept in the cradle, and data therein transferred to a new cell phone docked in the cradle. If the new cell phone has to be initially charged, charging in the cradle with PCMCIA card slot will enter all the private data into the new cell phone.

Those skilled in the art should understand that while the present invention may be embodied in hardware that alternative embodiments may include software or firmware, or combinations thereof. Such embodiments may include implementations using conventional processing circuitry such as, without limitation, programmable array logic (“PAL”), digital signal processors (“DPSs”), field programmable gate array (“FPGA”), application specific integrated circuits (“ASICs”), large scale integrated circuits (“LSIs”). Moreover, the present embodiment is introduced for illustrative purposes only and other embodiments that provide a system for and method of disabling a SIM card are well within the broad scope of the present invention. Conventional computer, and processing, system architecture is more fully discussed in Computer Organization and Architecture, by William Stallings, MacMillan Publishing Co. (3rd ed. 1993). Conventional processing system network design is more fully discussed in Data Network Design, by Darren L. Spohn, McGraw-Hill, Inc. (1993). Conventional voice and data communications are more fully discussed in Data Communications Principles, by R. D. Gitlin, J. F. Hayes and S. B. Weinstein, Plenum Press (1992), The Irwin Handbook of Telecommunications, by James Harry Green, Irwin Professional Publishing (2nd ed. 1992) and Voice & Data Communications Handbook, by Regis J. Bates, Jr. and Donald Gregory, McGraw-Hill (1996). Conventional electronic circuit design is more fully discussed in The Art of Electronics, by Paul Horowitz and Winfield Hill, Cambridge University Press, (2nd ed. 1989). Conventional control systems and architectures are discussed in Modern Control Engineering by Katsuhiko Ogata, Prentice Hall 1990. Each of the foregoing publications is incorporated herein by reference.

There has thus been shown and described a novel method and apparatus for both safeguarding and maintaining the integrity of the private data in a cell phone memory, which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A mobile communications device, comprising:
radio frequency circuitry configured to receive a radio frequency signal containing an on-air disable code;
a user interface through which a user of the mobile communications device can enter and set a disable code;
a memory configured to store a disable code entered by the user through said user interface;
match circuitry configured to determine whether the on-air disable code received by said radio frequency circuitry matches the disable code entered by the user and stored in said memory; and
circuitry configured to prevent access to private data stored in the mobile communications device if said match circuitry determines that the on-air disable code matches the disable code entered by the user and stored in said memory.

2. The mobile communication device of claim 1, wherein said circuitry configured to prevent access to private data stored in the mobile communications device comprises erase circuitry configured to erase private data stored in the mobile communications device.

3. The mobile communications device of claim 1, further comprising a memory card slot adapted to receive a memory card having memory configured to store said user entered disable code.

4. The mobile communications device of claim 1, wherein said circuitry configured to prevent access to private data stored in the mobile communications device includes circuitry configured to generate a disable or erase command.

5. The mobile communications device of claim 1, wherein the mobile communications device is configured to remain capable of communicating in a mobile communications network even after said circuitry configured to prevent access to private data stored in the mobile communications device operates to prevent access to the private data stored in the mobile communications device.

6. A method of safeguarding private user data stored in a first mobile communications device, comprising:
receiving a user-defined disable code through a user interface of the first mobile communications device;
storing said user-defined disable code in a memory of the first mobile communications device;
receiving an on-air disable code over a mobile communications network;
comparing the on-air disable code to the user-defined disable code; and
preventing access to private data stored in the first mobile communications device if the on-air disable code matches the user-defined disable code.

7. The method of claim 6, wherein the on-air disable code is sent and originates from a second communications device operated by said user upon the first communications device becoming lost or stolen.

8. The method of claim 1, wherein said disable code comprises an erase code and preventing access to private data stored in the first mobile communications device comprises erasing the private user data.

9. The method of claim 1, wherein the first mobile communications device is configured so that it continues to be capable of operating in said mobile communications network even after access to private user data is prevented.

10. A method of safeguarding private user data stored in a lost or stolen communications device, comprising:
receiving, by a first communications device that has been lost or stolen, a disable code originating from a second communications device;
comparing the received disable code to a preset disable code stored in said first communications device and previously entered into a programmable memory of the first communications device by the owner of the first communications device prior to the first communications device being lost or stolen; and
preventing access to private user data stored in the first communications device if the received disable code matches the preset disable code stored in the first communications device.

11. The method of claim 10, wherein preventing access to said private user data comprises erasing private user data stored in said programmable memory.

12. The method of claim 10, further comprising preventing said first communications device from being used to communicate with other communications devices.

13. A SIM card for a mobile communications device, comprising:
a memory adapted to receive and store a user-defined disable code when the SIM card is configured in a mobile communications device; and
disabling circuitry configured to prevent access to private user data stored in a memory of a mobile communications device, when the SIM card is configured in a mobile communications device and an on-air signal received by the mobile communications device contains a disable code that matches a preset, user-defined disable code stored in said memory.

14. The SIM card of claim 13, wherein said disabling circuitry is further configured to erase private user data stored in the memory of said mobile communications device, if the disable code in the one-air signal matches the preset, user-defined disable code.

15. The SIM card of claim 13, wherein said memory is further adapted to store private user data and said disabling circuitry is further configured to prevent access to that private user data, if the disable code in the one-air signal matches the preset, user-defined disable code.

16. The SIM card of claim 15, wherein said disabling circuitry is further configured to erase the private user data stored in the SIM card memory, if the disable code in the one-air signal matches the preset, user-defined disable code.
